(19) United States
(12) Patent Application Publication
(10) Pub. No.: US 2014/0114679 A1
(43) Pub. Date: Apr. 24, 2014

(54) METHOD OF ANATOMICAL TAGGING OF FINDINGS IN IMAGE DATA

(71) Applicant: Martin Erskine Anderson, Bothell, WA (US)

(72) Inventor: Martin Erskine Anderson, Bothell, WA (US)

(73) Assignee: HIGH TECH CAMPUS 5, EINDHOVEN (NL)

(21) Appl. No.: 14/127,663

(22) PCT Filed: Jun. 25, 2012
(86) PCT No.: PCT/IB2012/053202

§ 371 Date: Dec. 19, 2013

Related U.S. Application Data
(60) Provisional application No. 61/501,487, filed on Jun. 27, 2011.

(51) Int. Cl. G06F 19/00

(52) U.S. Cl. CPC G06F 19/321
USPC 705/2

(57) ABSTRACT

A clinical findings management system enables a clinician to review medical diagnostic images and mark or “tag” locations of suspect anatomy in the images. The tagged findings of a review are stored in association with a particular patient, particular anatomy, and location in the anatomy as marked by the placement of the tag. Serial studies performed of the particular anatomy over time are compared and the evolving diagnostic data of a particular finding is accumulated and saved. The clinician is thus able to recall the diagnostic history of a particular finding resulting from studies of the anatomy performed over time.

This invention relates to medical diagnostic imaging systems and, in particular, to diagnostic imaging systems which display a history of anatomical findings over serial studies.

When a clinician reviews the images from a clinical exam, the clinician is looking for anatomy or characteristics of anatomy which are abnormal or suspicious. Some findings do not call for immediate treatment or therapy, but bear watching over a period of months or years. In subsequent exams of the patient, the clinician will look for anatomical findings noted in a previous exam and look for any adverse changes in anatomical development or function. One type of finding which generally always requires follow-up is anatomy which has been treated in the past. The clinician will look for that anatomy in subsequent exams, to see that the treatment was and remains effective, and that a potential or actual malady has not recurred or spread. Another type is anatomy undergoing therapy, the efficacy of which may be monitored by follow-up.

To follow up on a finding noted in a previous exam, the clinician must review the results of the patient's previous studies (exams). Sometimes this means that the clinician must order the patient's medical record and search for the results of previous studies. The images acquired during a previous study may be electronically available on the information system of the hospital or clinic, which can expedite such a review. But images from previous studies may have been acquired by other clinicians, and a review of notations of the images is required. In other cases, the previously acquired images may have been acquired by a different imaging modality. For instance, images from a previous exam may have been acquired by mammography, CT, or MRI, while the current exam is being performed with ultrasound. The clinician can then encounter difficulty in relating the images of different modalities. In all of these instances, there may be numerous findings which have to be located and related to the images from the current exam. It is desirable for the clinician to have an efficient and convenient way to map the findings of previous studies to the anatomy shown in the images of the current exam, and to be able to have findings of particular anatomy for which follow-up is called for immediately available for all previous findings and from the historical records of all previous studies.

In accordance with the principles of the present invention, the management of clinical findings among multiple diagnostic procedures (such as initial assessment and subsequent biopsy) and imaging data sets collected in different geometries, by different imaging modalities, and/or exams or procedures is facilitated automatically. Radiological findings, clinical observations, histological findings from biopsies, interventional procedures, and so forth are associated with a unique identifier (“tag”, or label) linked to a chosen location in the patient's anatomy and tracked among images, data-sets, and clinical records on an anatomical basis. A unique identifier tied to a physical location identified in imaging data thus acquires a history consisting of all the clinical data associated with it, preferably encoded as linked electronic records. An implementation of the present invention leads to the integration of these concepts in a semi-automated workflow that assists the clinician in recording, associating, tracking, and following up a multiplicity of findings, where findings are understood to mean any aspect of the data of clinical interest. Such anatomically intelligent annotation can be cross-linked to clinical information systems to enable the integration of functions of PACS, image analysis workstation, and CIRS systems in a single workflow.

In the drawings:

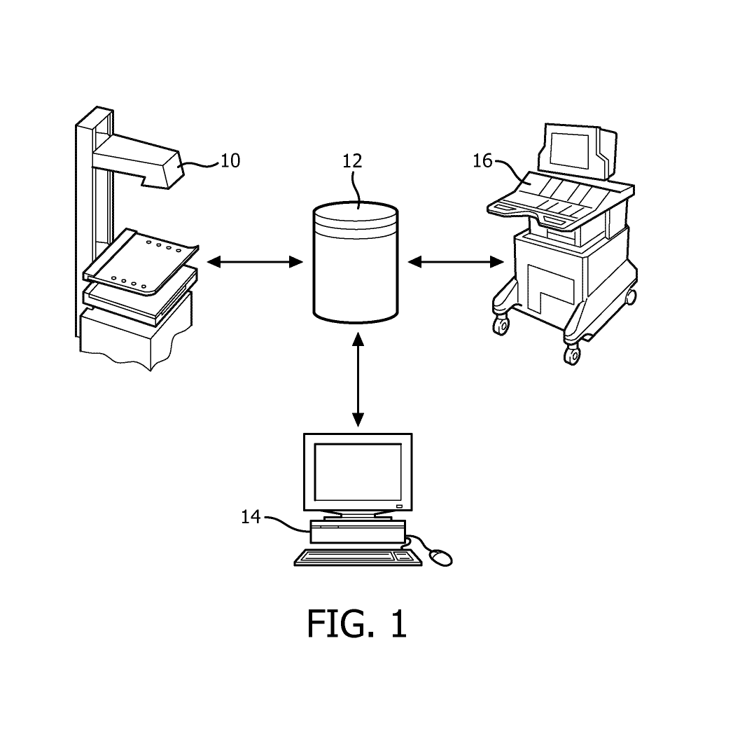

FIG. 1 illustrates the connection of image data from different diagnostic imaging modalities to a common database in which clinical findings are inter-related.

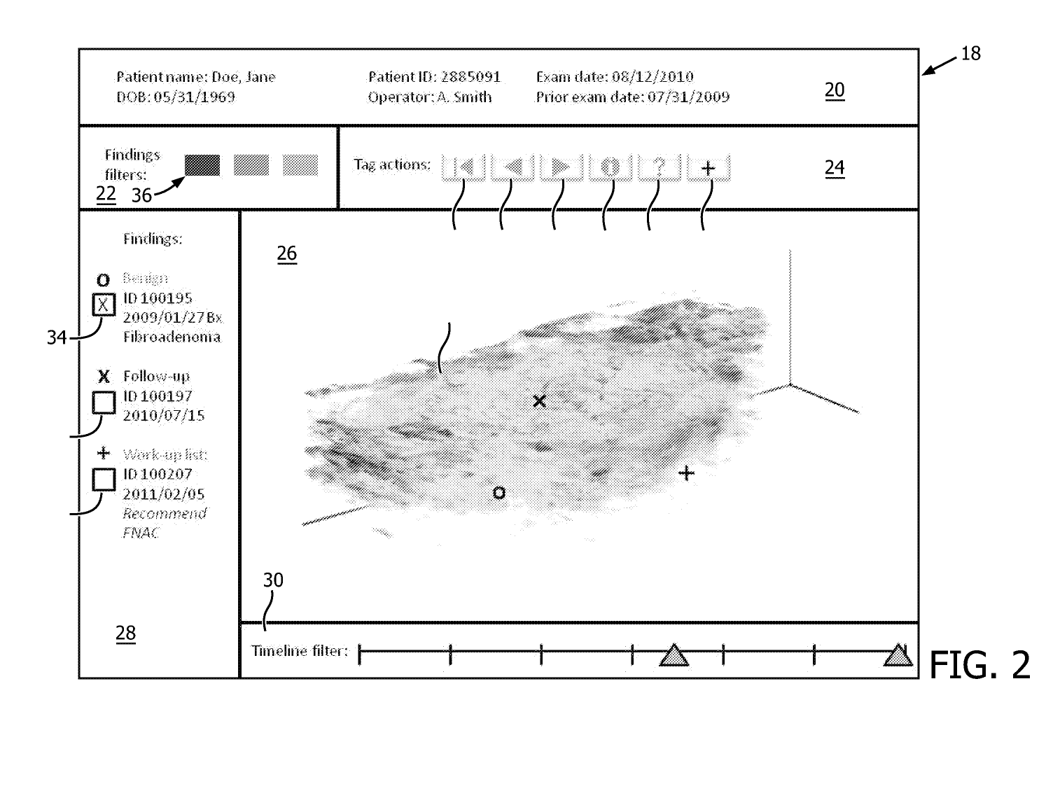

FIG. 2 illustrates an ultrasound system or review workstation display screen on which findings in displayed anatomy can be marked and previously diagnosed images recalled.

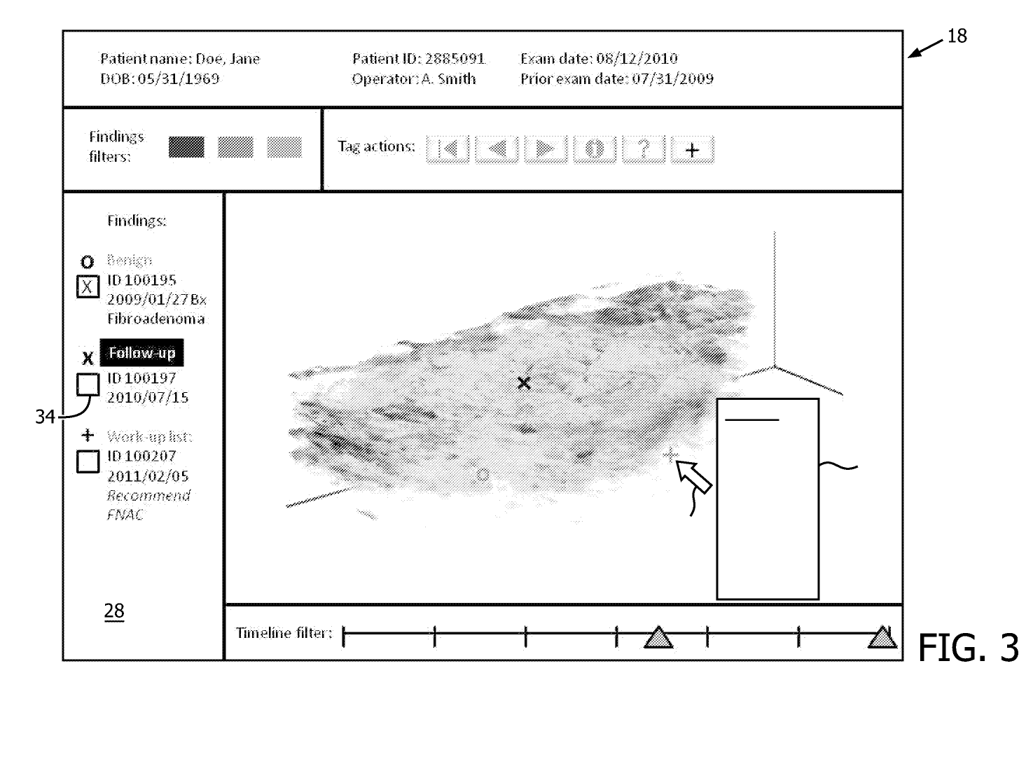

FIG. 3 illustrates an ultrasound system or review workstation display screen on which an anatomical finding has been designated for follow-up.

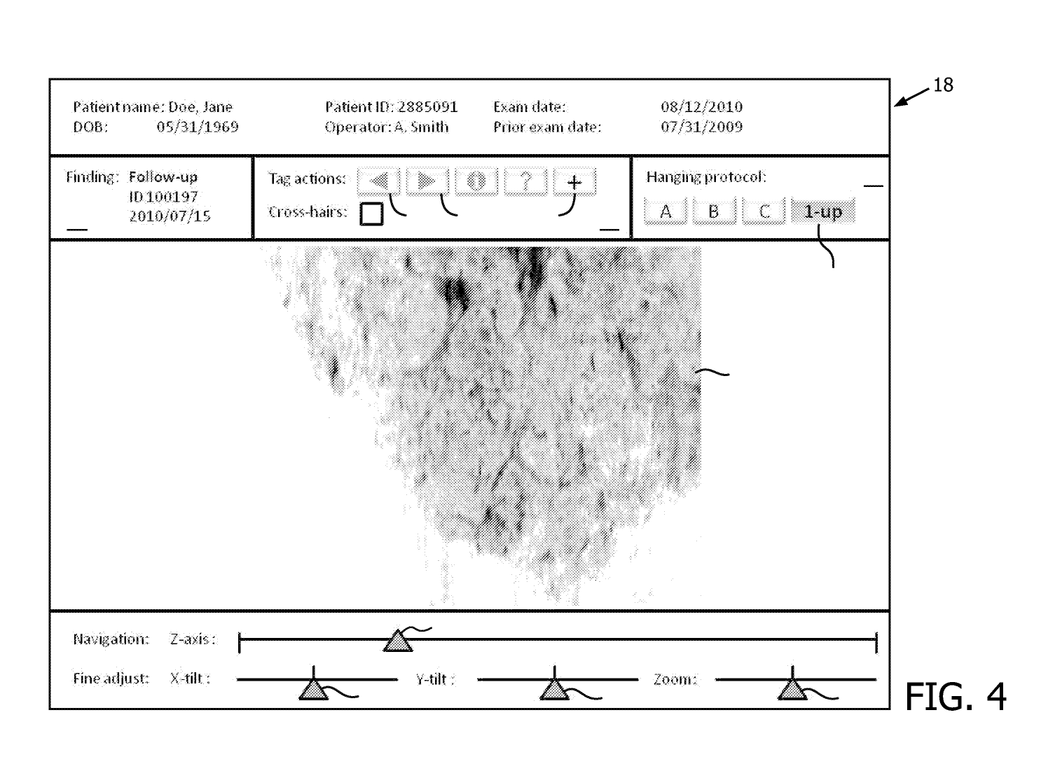

FIG. 4 illustrates an ultrasound system or review workstation display screen showing navigation through a 3D image dataset.

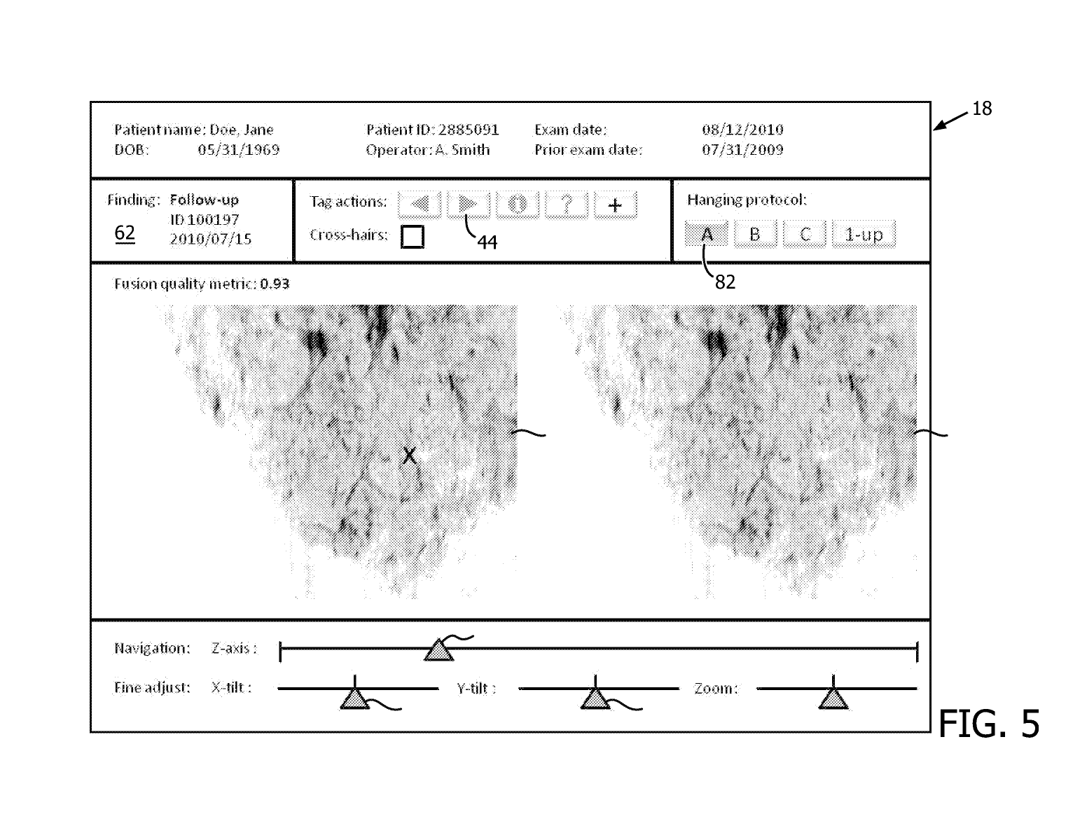

FIG. 5 illustrates the review of an 3D image dataset in synchronism with a previously diagnosed 3D image dataset.

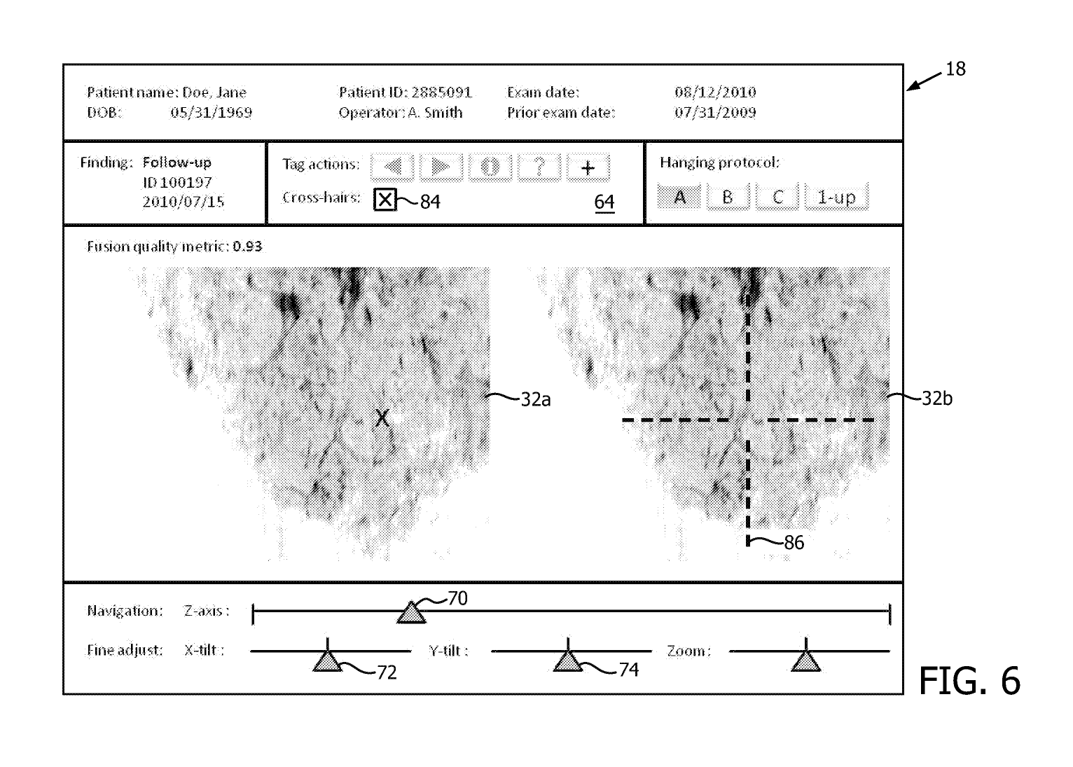

FIG. 6 illustrates a cross-hair indicator which indicates in a new image dataset the location of a finding found in a previously diagnosed dataset.

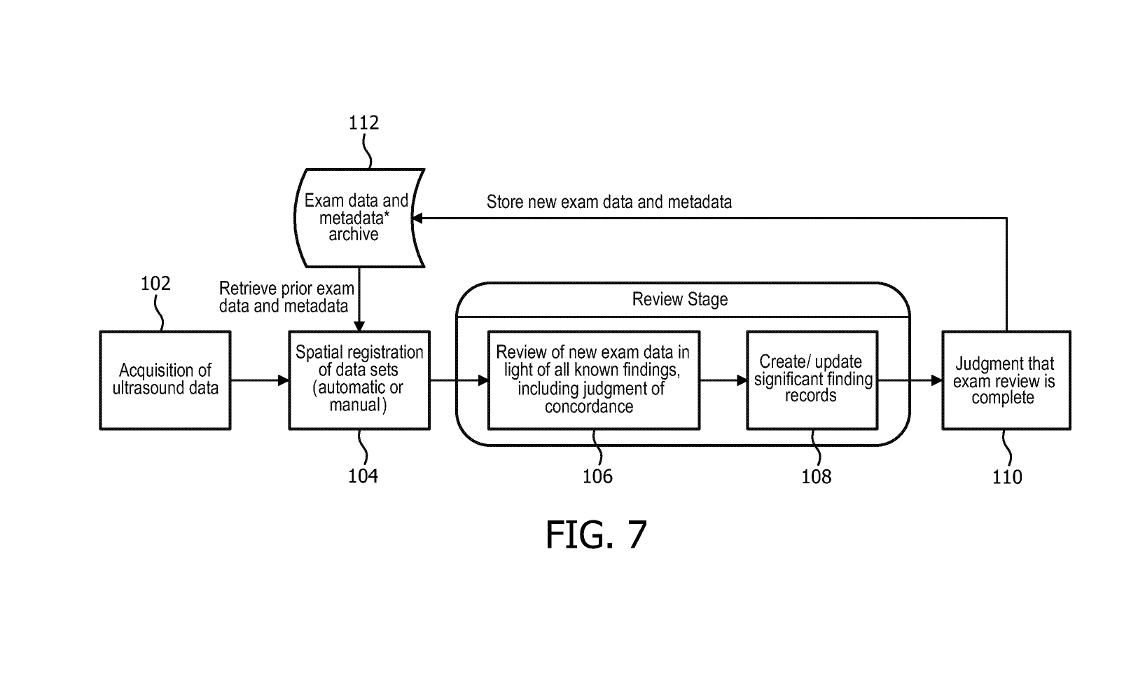

FIG. 7 illustrates a workflow of the diagnosis of a new image dataset in relation to the findings of a previous study in accordance with the principles of the present invention.

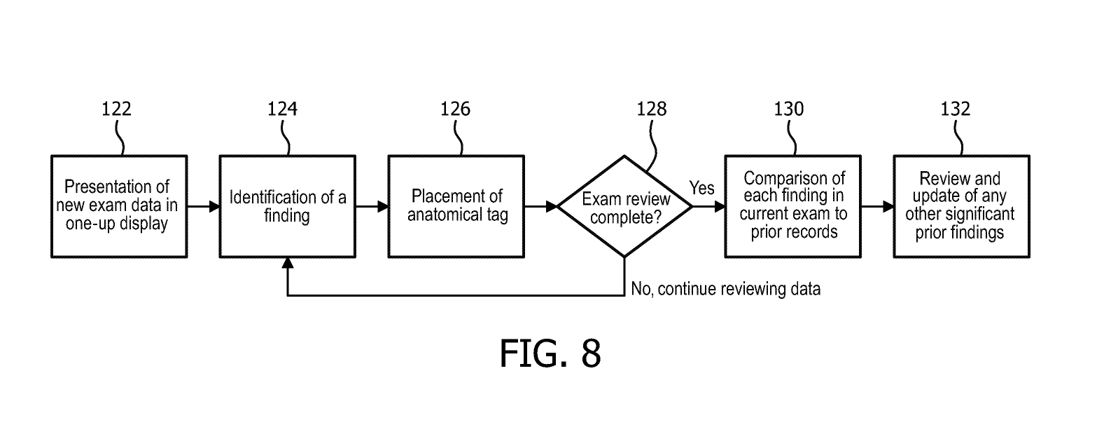

FIG. 8 illustrates a workflow of the diagnosis of a new image dataset without display of a previous study.

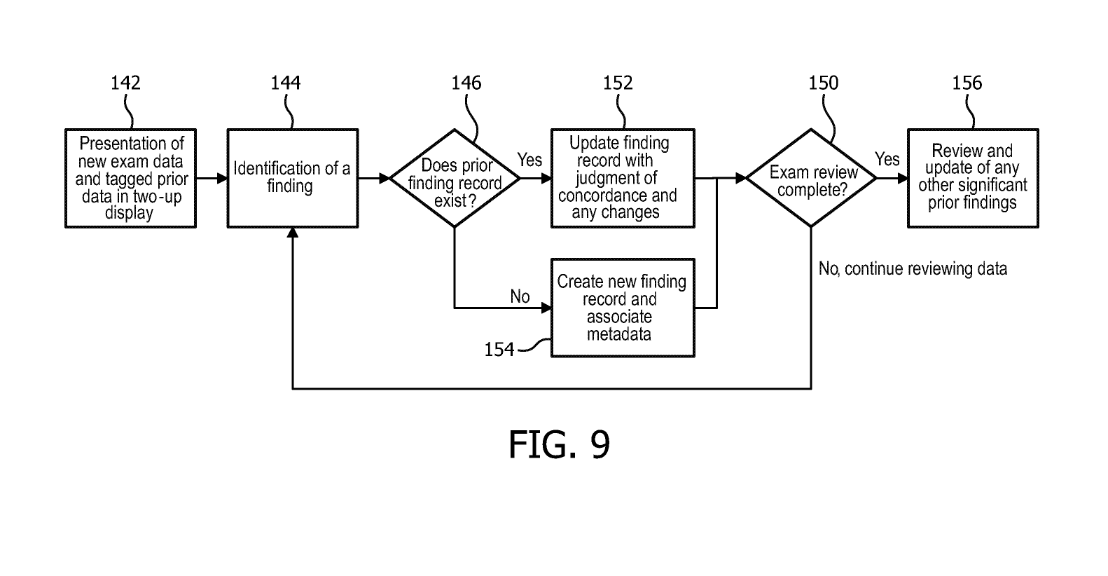

FIG. 9 illustrates a workflow of the diagnosis of a new image dataset when displayed side-by-side with a previously diagnosed image dataset.

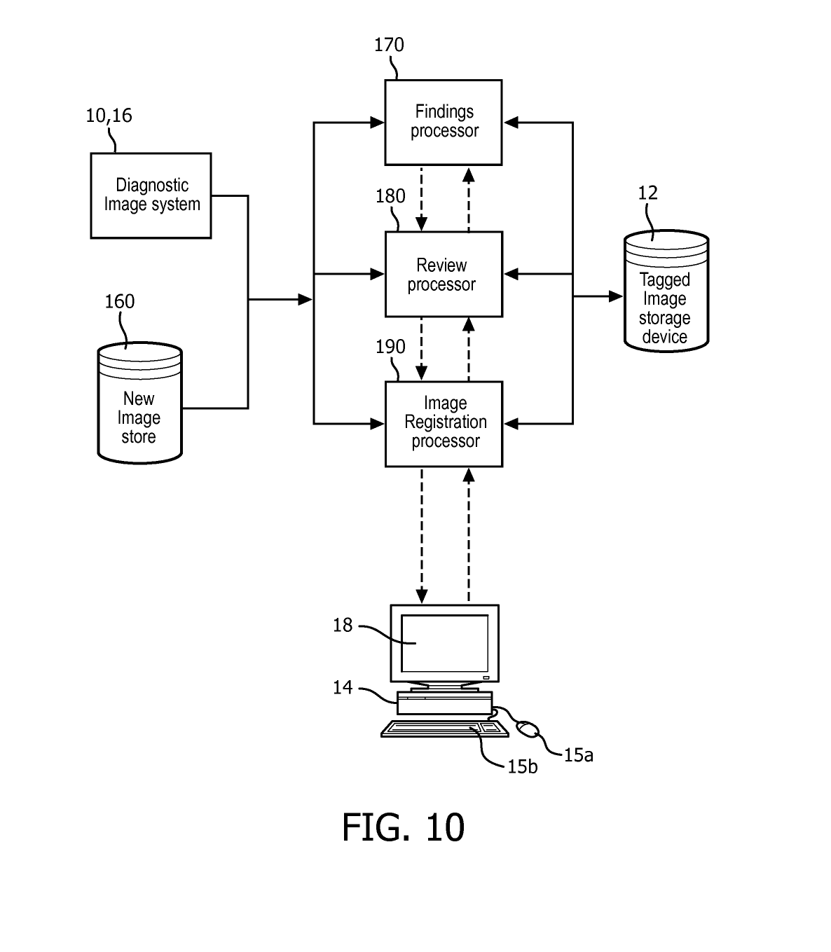

FIG. 10 illustrates a diagnostic image review system for clinical findings management in accordance with the present invention.

Referring first to FIG. 1, a network of diagnostic imaging system of different modalities is shown which is suitable for the management of the findings of serial studies in accordance with the principles of the present invention. The illustrated network includes a mammography system 10 for performing a breast examination. Images acquired by the mammography system are reviewed and any suspicious areas or bodies in the breast are marked as findings. The mammography images may be reviewed on an image diagnosis workstation 14 which is connected to the network. The mammography images are stored on a storage device 12, which may be the storage device of a PACS system or hospital information system. In this example one or more of the findings are marked for further study by an ultrasound exam. An ultrasound system 16 performs a follow-up study in accordance with the principles of the present invention. Ultrasound images of the patient's breast are acquired and findings located in the images. The findings are anatomically tagged and their locations are correlated with findings of the mammography images. This may be done on the image workstation 14 or on the ultrasound system. When the findings are spatially matched, the diagnostic system will display an image and its marked findings, and the diagnostic history of each finding from the serial studies is displayed to the clinician.

A display screen 18 of a clinical findings management system constructed in accordance with the present invention is shown in FIG. 2. In this example the findings management system is being used to review a study in which anatomical findings have previously been tagged. At the top of the screen is information identifying the patient. A central concept of the present invention is that the historical data of all of the anatomical findings of a patient are managed for a particular patient. The diagnostic image 32 which is being reviewed is displayed in the large central area 26 of the screen. In this example the image being reviewed is a three dimensional (3D) ultrasound image 32 of the patient's breast tissue. The tagged findings of a diagnosis of the image are shown in their anatomical positions in the tissue by symbols “◯”, “×” and “+”, each marking the location of a particular finding. The system may also indicate the approximate location of prior clinical findings identified by means other than volumetric imaging, e.g., a palpable lesion found during a clinical exam. Detailed information about these findings is listed in the areas 28 on the left side of the screen. Each finding in the list includes a small box 34, which a clinician can check as each finding is reviewed. The list thus is in the form of a checklist by which the clinician can check off each finding as it is reviewed, providing an orderly review format which assures that each finding will be reviewed. In this example the box for finding ID 100195 (“◯”) is checked, indicating that this finding has been reviewed. The following two finding have not yet been reviewed as indicated by the empty boxes 34.

There are several ways in which the clinician can be selective as to the findings shown on the screen. One is a clinical significance filter shown in area 22 of the screen. In this example there are three buttons 36 which are colored red, yellow, and green from left to right. Clicking on the red button on the left with a user control 15a, 15b (see FIG. 10) will cause only the most significant (most important, e.g., suspicious) findings to be shown in the anatomy 32. Clicking on the yellow button will cause findings previously recommended for follow-up to be displayed, and the green button causes findings proven benign by clinical means such as a biopsy to be displayed in the anatomy 32. By means of these buttons the clinician can select which findings to display by the clinical significance of the findings.

A second technique for selecting the findings to be displayed is the timeline filter in the lower area 30 of the screen. This timeline filter has two triangular symbols which the clinician can slide left or right along the timeline. The gradations of the timeline can be set to units of weeks, months, or years. The clinician slides the symbols to encompass the period of time for which the findings are displayed. For example, the clinician may set the symbols at the present (far right) and one year previous. The findings to be displayed will then be those marked during the previous year. Setting the timeline to years and sliding the symbols to the far left and right will cause all findings for this patient to be displayed and recalled.

In accordance with the principles of the present invention, the display screen includes a series of buttons in area 24 by which the user can create and review anatomical tags of findings in the diagnostic image. The processing of findings for tagging, association, storage and review is performed by a findings processor 170 shown in FIG. 10 and implemented by the hardware and software of an image diagnosis workstation 14 or diagnostic imaging system 10, 16. In the illustrated implementation, the buttons also enable the clinician to step through findings already marked on the diagnostic image 32. The first three buttons enable the clinician to step through and review findings already made in the image. Clicking on button 40 causes the system to go to the first finding on the image. The details of the first finding will appear at the top of the list in area 28 of the screen and the first finding will be shown and, if desired, highlighted in the image 32. If the image is a 3D image, the system may progress through 2D slices of the 3D anatomy to display the 2D cross-section in which the first finding is seen. Alternatively, the anatomy may be shown in 3D as it is in FIG. 2, with the first finding highlighted. Clicking on the back arrow 42 causes the display to go back to the previous finding of the list. Clicking on the forward arrow 44 causes the display to go ahead to the next finding on the list. Clicking on the information button 46 will cause the system to display all of the diagnostic detail of the history of a finding, such as tag history, presentation states (i.e., previously selected image reconstructions within the 3D dataset), annotations, measurements, and so on. This information may be a compilation of other sources of clinical data associated with a particular finding. This information may be stored as metadata associated with the particular finding. Clicking on button 48 enables the clinician to amend the information stored for a particular tag. Clicking the “+” button 50 enables the clinician to create a new tag for a finding. This may become necessary on review if, during the review, the clinician observes a particular anatomical characteristic that was not tagged as a finding previously, for instance. In that case, the clinician will click button 50 to add a marked finding the the anatomy and will place a new finding symbol on the newly discovered anatomy of interest.

FIG. 3 is an example of use of a clinical findings management system of the present invention to query the diagnostic history of a tagged finding. In this example the anatomical finding has been tagged with a “+” symbol. The list in area 28 at the left side of the screen indicates that a workup is to be done for the finding marked “+” to acquire further information on the suspect anatomy. In this example the clinician has moved the cursor 52 to point at the “+” symbol. As this happens, a tool tip graphic 54 appears near the cursor. This graphic shows the diagnostic history of this finding, which in this example has been identified as ID 100207. As seen in the drawing, this history gives pertinent information about the finding and the clinical decisions made with regard to the finding ID 100207 in past studies of the anatomy. In this example the diagnostic history from past studies of the finding appear automatically in the tool tip. Alternatively the diagnostic history of the tagged finding can be displayed in other ways or in other areas of the screen. For instance, if the clinician clicks on the finding symbol, the diagnostic history of the tagged finding appears in the display area 28 in larger font on the left side of the screen in place of the list of findings. Right-clicking on the display area 28 returns the list of findings to the display area.

In the screen display of FIG. 3 it is seen that the designation “Follow-up” from a previous exam for finding ID 100197 is highlighted. This is because this finding is next in the list of tagged findings to be reviewed but, in this example, the clinician has interrupted the sequential review of the findings list to look at finding ID 100207 as described above. The highlighting flags the clinician to note that follow-up review is needed for finding ID 100197, and that the clinician should check the box 34 for this finding when the review is complete. In this way the management systems assists in preventing a finding from being overlooked and not reviewed by the clinician.

FIG. 4 illustrates a display screen of a clinical findings management system of the present invention which is used to conduct a review and diagnosis of a new ultrasound image. The ultrasound image 32 is a 3D image of patient breast tissue. Area 66 on the right side of the screen presents the user with a number of buttons designated “Hanging protocol,” by which the clinician can set the screen 18 for the desired type of display, analogous to the conventions for the arrangement of x-ray films on a viewing box (transilluminator), from which this term derives its name. In this example the clinician has clicked button 78 for a “1-up” display, which is the display of only a single image. The clinician is prompted for actions to be taken during this study by notes which appears in area 62 of the screen. In this example the note reminds the clinician to do a follow-up review of tagged finding ID10097, which should be done by Jul. 15, 2010 in this example. If the exam has been designated for follow-up on a number of findings, clicking the forward arrow 44 or the back arrow 42 enables the clinician to move from one finding to another. For diagnosis of a 3D image, a thorough review is done by moving progressively through a series of parallel 2D slice images of the 3D anatomy. The clinician slides the Z-axis (depth) navigation symbol 70 to move from shallow depth slices to deeper slices and back again. With this control the clinician can swim through the slices from the shallowest to the deepest depth and look for suspicious anatomy in each 2D image slice. Again, to assist the clinician whose review has been interrupted, the system can graphically indicate whether portions of the dataset have yet to be reviewed, regardless of whether prior findings are tagged therein. Use of the forward and back arrows 44 and 42 will automatically cause the system to move to the next 2D slice (or a previous one) on which a finding has been tagged for follow-up. By adjusting the X-tilt control 72 and the Y-tilt control 74 the clinician can finely adjust the orientation and attitude of the 3D image 32, which affects the direction of the Z-axis and hence the direction along which the 2D slice images, normal to the Z-axis, are arrayed. The clinician can zoom in on any suspicious anatomy for a closer review by manipulation of the Zoom adjustment 76, and by panning the image up, down, left or right with the cursor on the screen. If the clinician finds suspicious anatomy which has not been tagged previously, the clinician clicks the “+” button 50 to create a new tag, then clicks the cursor at the anatomical point in the image where the finding is to be marked. In response, a new finding symbol is placed on the image and its position in the anatomy and in relation to the locations of other findings are recorded by the system and associated with the finding and anatomy. Recording the anatomical location of a finding is useful in a side-by-side comparison of an image from a new study and a diagnosed image from a previous study as discussed below.

FIG. 5 illustrates a display screen of a clinical findings management system in which an anatomical image 32b from a new study is diagnosed in comparison with an image 32a from a previous study which was previously diagnosed and anatomical findings marked. To do such a side-by-side review, the clinician clicks the “A” button 82 for a hanging protocol which displays two images side-by side as shown on this screen. The two images 32a and 32b may be from the same or different modalities, that is, both may be ultrasound images or one may be a CT, MRI, or mammography image and the other an ultrasound image. Since the two images are of the same anatomy, in this example both images of the same breast tissue, the old and new images may be anatomically aligned in the same orientation. This may be done using known image fusion techniques such as the image fusion capability available on the Percunav™ image guidance system with image fusion, available from Philips Healthcare of Andover, Mass. Image matching techniques may also be used, such as those used to stitch digital photographs together to form a panoramic image or those used in medical diagnostic panoramic imaging, in which a sequence of images are stitched together as they are acquired. Common image matching techniques use block matching, in which arrays of pixels from two images are manipulated to find a difference between them which meets a least squares (MSAD) fit. These techniques are useful for both 2D and 3D medical images as described in U.S. Pat. No. 6,442,289 (Olsson et al.) and (attorney docket PH010375-Yoo et al.), and can also allow a 2D image to be aligned with the corresponding projection or tomographic section in a 3D dataset. Image orientation alignment (registration) is performed by the image registration processor 190 of the workstation or imaging system shown in FIG. 10. The images can also be anatomically aligned manually by manipulating one until the same image or image plane is seen in both images. Since anatomy will change over time and appear slightly different from an earlier study to a later study, and images of the same anatomy from different modalities will also have a different appearance, the result of the automated alignment method of the present invention is scored and presented to the clinician as a fusion quality metric. As seen in the example of FIG. 5, the two images were matched with a quality metric of 0.93 on a scale of zero to one. The clinician can see at a glance how closely the system believes it has matched the two images to the same viewing orientation. If the clinician in his or her judgment disagrees with that assessment or the system returns a low fusion quality metric, the clinician can then manipulate the manual controls at the bottom of the screen to tilt and/or swim through the slices of one of the images until the clinician believes a satisfactory orientation match has been achieved.

With their orientations matched, the findings management system will then manipulate and swim through both images in synchronism. Image review is assisted by a review processor 180 of the workstation or imaging system as shown in FIG. 10. For instance, when the clinician moves the slider 70 to move to a deeper or shallower slice in one image, the other image will simultaneously follow to the same image at the same depth. The clinician is thus viewing the same tissue in both images, one from an earlier study and the other from a later study. Differences in anatomy which ostensibly should be the same are thus more easily discerned by the clinician.

The clinician also has the review option of moving from one tagged finding to another in the old image, and have the findings management system move to the same anatomy in the new image. This is possible due to the parallel and synchronous stepping of both images simultaneously. This enables a clinician to quickly progress through a sequence of prior findings in previous images to tag and diagnose them in the new images from a new study. For example, in FIG. 5 the clinician has clicked on the “Forward” tag action button 44 and the image 32a of the previous study has moved through the planes of the tissue volume and stopped at the image plane with the “×” symbol tag marking the location of finding ID 100197, as indicated in area 62 at the upper left of the screen. The new image 32b on the right has simultaneously stepped to the same image plane. The clinician can now examine the same image plane in the new image to quickly find the same finding and discern whether it is the same or has changed, and make the appropriate diagnosis. The clinician will also tag the anatomical location of the finding in the new image with the same “×” tag. Since the anatomy may have changed over time or the new image may be from a different imaging modality, the image plane initially seen in the new image may not be the exact plane of finding ID 100197. In that case, the clinician can use the Z-axis navigation control slider 70 to move the view of the new image to the next or subsequent image plane until the anatomy of the finding is seen in the new image 32b and is then available for tagging and diagnosis. The clinician can also make these adjustments by adjusting the X-tilt control 72 or Y-tilt control 74.

FIG. 6 illustrates a display screen 18 of an implementation of the present invention with a cross-hairs feature to aid the clinician in spotting a previously tagged finding location in new image 32b. The clinician clicks on the “Cross-hairs” box 84 in area 64 of the display screen which causes cross-hair graphic 86 to appear over the new image with the corresponding location of the “X” tagged finding in the center of the cross-hairs. The cross-hairs are open in the center so as not to obscure the image location where the finding should be. As before, if the clinician does not see the suspect anatomy in the center of the cross-hairs in the new image, the navigation controls 70, 72 and 74 can be carefully adjusted by the user to move the new image view to an adjacent or nearby image plane where the anatomy may be found in the new image.

FIG. 7 illustrates a high-level flowchart of the workflow of a diagnosis conducted in accordance with the principles of the present invention. At the first step 102 image data is acquired. In this example the image data is ultrasound image data, but images from any diagnostic imaging modality may be used. At step 104 image data sets are spatially registered, if there are images from different serial studies or modalities retrieved from a data archiving device 12, 112. In the first step 106 of the review stage, the new image data is reviewed in light of all known findings if findings were tagged in any previous study. In making this review the clinician will apply his or her diagnostic judgment of the concordance of the past and current images and their findings. In step 108 the clinician updates the diagnostic records of the findings in light of what is found in the new images. At step 110 the clinician concludes that the exam review is complete. The new exam data and its metadata, which includes all diagnostically relevant information beyond the image data, such as anatomical tags and their locations, presentation states, annotations, measurements, and any other relevant clinical data, is stored in a data archiving device at step 112.

FIG. 8 illustrates a typical workflow for a 1-up display review in accordance with the present invention, when only the new image is displayed and reviewed. At step 122 the new image data is presented in a 1-up display. At step 124 a finding is identified in the image data. At step 126 an anatomical tag is placed on the image data at the location of a finding. Steps 124 and 126 are repeated until the entire relevant anatomy in the image data has been reviewed. When the review is complete (step 128), the findings marked in the current image data set are compared with the findings information of one or more prior exams. At step 132 the record of findings following the previous exam are reviewed and updated as called for by the information discerned from the current review.

FIG. 9 illustrates a typical workflow for a two-up (side-by-side) display exam in accordance with the present invention. In step 142 the image data of a new exam and anatomically tagged image data from a prior exam are displayed side-by-side. At step 144 a finding is identified in the new image data. The system displays the same anatomical location in the prior image data so the clinician can determine whether a record of the finding exists in the prior image data. If it does, in step 152 the finding record is updated as to the concordance of the data and any relevant changes noted. If the finding does not exist in the prior image data, a new finding record is created in step 154 with its accompanying relevant metadata. Steps 144-154 are repeated until the exam review is complete at step 150, whereafter the information on findings as of the prior exam is reviewed, updated, and archived.

FIG. 10 is a block diagram of a clinical findings management system of the present invention. New images for review and diagnosis are provided by one or more diagnostic imaging systems 10, 16 or from a new image storage device 160 which may comprise diagnostic images acquired and then stored on a PACS or CIRS system, for instance. Non-image medical diagnostic data may also be resident in the patient records stored on the PACS or CIRS system and provided to the findings management system for association with tagged findings. Image review and findings tagging, association, storage and display is conducted by the findings processor 170 and review processor 180 implemented on the workstation 14 or diagnostic imaging system 10, 16. The image registration processor 190 is implemented in the same manner to assist the above-described two-up review of old and new images. Images with their tagged findings and findings-associated image and non-image clinical data is stored on the tagged image storage device, from which it can be retrieved and used in the review of new images, diagnosis, and clinical reporting.

Other variations and features are possible in an implantation of a clinical findings management system of the present invention. The system can be programmed so that, when the clinician clicks on a finding in the list of findings in area 28 of the display screen, the selected finding is highlighted in the image. This is advantageous when an image is showing multiple findings, or the same symbol is used to mark each tagged finding. In an image displaying multiple findings, another useful feature is to hide (not display) all other findings when the clinician clicks on a specific finding. In addition to tagging suspect anatomy, it is also possible to tag other anatomical landmarks and fiducials in an image. When images from different studies are tagged in this way, the locations of the tagged landmarks and fiducials can be used to register the images, and an automated registration system becomes more robust when alignment is performed using commonly tagged landmarks and fiducials. The clinical findings management system could also be applied more generally as a means to rapidly review a patient's medical history in a region of the patient's anatomy, contributing e.g. to the prevention of unnecessary tests or procedures.

Since a clinical findings management system of the present invention accumulates tag data of findings as updated over time, a clinician is able to select or click on a particular finding and immediately see its entire diagnostic history. This information helps the clinician to track multiple findings in a patient's anatomy and immediately see how suspect anatomy and its diagnoses have evolved over time.

As seen from the above, a central concept of the present invention is a unique electronic identifier (“tag”) linked to a spatial location in volumetric data, coupled with the capabilities of medical image and data retrieval systems to perform relevant operations on this tag in order to associate additional clinical data with it. Each tag becomes part of that patient's medical record, such that either subsequent findings, be they other image data or clinical data, can be associated with that tag, and/or subsequent actions performed based on that tag's location.

Once the infrastructure to interactively manage anatomical tags is in place, there are numerous practical implications and advantages for many aspects of radiological review and clinical information management. Entries in a clinical information system can be cross-linked to anatomical tags in a PACS, allowing the user to call up all relevant data in a single step by accessing the tag. Tags can also be used to facilitate image review of a screening exam, in that the objective of the screening exam is to determine (a) if there are any new findings, and (b) if any of the previous findings have changed. The radiologist's task of detection and interpretation of findings is obviously unchanged, but the task of keeping track of a multiplicity of findings is simplified. For instance, if a radiologist encounters a finding with no tag, it is immediately clear that this is a new finding, whether genuinely new or missed in a prior exam. After screening for new findings, the radiologist can also quickly jump to each pre-existing tag location to check for any changes relative to prior exams, satisfying the obligation to follow up indeterminate lesions, and/or to monitor the location of prior treatment for recurrence. In the case of intra- or inter-modality fusion, the system can reproduce from the fused image volume the reference views associated with tags in the existing volume(s).

A clinical findings management system of the present invention can also indicate whether every finding previously tagged for follow-up has been reviewed during the current session, helping the radiologist verify that follow-up is complete. An automated system can also alert the radiologist if certain findings have not been reviewed at the recommended follow-up interval, prompting immediate review. This aspect introduces the concept of a “protocol” to the reading of screening results. Whether referred to as “protocols” or “checklists”, such clinical workflow aids have been shown to improve the consistency and accuracy of medical care.

What is claimed is:

1. A method for managing clinical findings from serial studies of an anatomy of a patient comprising:
acquiring a first medical diagnostic image;
reviewing the image to identify a finding;
placing an anatomical tag at the location of the finding in the image;
comparing findings tagged in the first image with findings tagged in a second medical diagnostic image of the same anatomy; and
updating a record of findings of the first and second images with findings information of the first image.

2. The method of claim 1, further comprising:
selecting a finding; and
displaying diagnostic information of the finding which was acquired in studies conducted at different times.

3. The method of claim 1, further comprising:
selecting a finding; and
displaying diagnostic information of the finding which was acquired in studies conducted with different imaging modalities.

4. The method of claim 1, further comprising concurrently displaying the first and second medical diagnostic images.

5. The method of claim 4, further comprising anatomically aligning the first and second medical diagnostic images for display.

6. The method of claim 5, further comprising sequentially displaying pairs of anatomically aligned images of the same anatomical region.

7. The method of claim 6, further comprising indicating an expected location of a finding in the first medical image when a tagged finding is shown in the second medical diagnostic image.

8. The method of claim 5, further comprising displaying a quality metric of the quality of the anatomical alignment of the first and second medical images.

9. The method of claim 5, further comprising manually adjusting the anatomical alignment of the first and second medical diagnostic images.

10. The method of claim 1, further comprising displaying a plurality of findings of the second medical diagnostic image while reviewing the first medical diagnostic image to identify a finding.

11. The method of claim 1, further comprising updating the record of findings of the first and second images with non-image clinical information which relates to one or more of the findings.

12. The method of claim 11, further comprising:
selecting a finding; and
displaying diagnostic information of the finding comprising both image information and non-image information.
